(19) United States
(12) Patent Application Publication
(10) Pub. No.: US 2012/0120343 A1
(43) Pub. Date: May 17, 2012

(54) LIGHT-EMITTING MODULE, LIGHTING DEVICE, DISPLAYING DEVICE, AND TELEVISION-RECEIVER DEVICE

(75) Inventor: Kaori Yamamoto, Osaka (JP)

(73) Assignee: SHARP KABUSHIKI KAISHA, Osaka (JP)

(21) Appl. No.: 13/378,159

(22) PCT Filed: Mar. 15, 2010
(86) PCT No.: PCT/JP2010/054307

§ 371 Date: Dec. 22, 2011

(30) Foreign Application Priority Data
Jun. 15, 2009 (JP) 2009-141911

(51) Int. Cl. G02F 1/1335; F21V 13/04; F21V 5/04

(52) U.S. Cl. 349/61; 362/311.01; 362/244; 362/245

(57) ABSTRACT

An LED module (MJ) includes an LED (22), and a lens (11) that transmits light from that LED (22) therethrough. In this LED module (MJ), a depression (11D) is formed on a lens surface (11S) of the lens (11) where it overlaps the LED (22), and furthermore, a prescribed formula is satisfied.

### TECHNICAL FIELD

The present invention relates to a light-emitting module including a light source such as a light-emitting element, a lighting device having the light-emitting module, a display device equipped with the lighting device, and further to a television-receiver device equipped with the display device.

### BACKGROUND ART

In a liquid crystal display device (display device) equipped with a non-light-emitting type liquid crystal display panel (display panel), usually, a backlight unit (lighting device) for supplying light to the liquid crystal display panel is also mounted. There are various kinds of light sources for the backlight unit. For example, in the case of a backlight unit disclosed in Patent Document 1, the light source is an LED (Light Emitting Diode).

Further, in this backlight unit, as shown in FIG. 17, lenses 111 for transmitting light from LEDs 122, which are mounted on a mounting substrate 121, are attached (here, a module including a mounting substrate 121, an LED 122 and a lens 111 is referred to as a light-emitting module “mj”). This way, light shown in FIG. 17 (see single-dot chain arrow lines) is converged by the lenses 111, and travels to follow the vertical direction as compared to light of the LEDs 122 that is emitted without going through the lenses as shown in FIG. 18. Accordingly, the luminance in the front view is increased for the backlight light from the backlight unit.

### Related Art Documents

### Patent Documents

Patent Document 1: Japanese Patent Application Laid-Open Publication No. 2008-293858

### SUMMARY OF THE INVENTION

### Problems to be Solved by the Invention

When a camera captures the front view luminance of the two LEDs 122 as shown in FIG. 17, an image shown in FIG. 19 is obtained (here, when capturing this image, a diffusion plate is interposed between the camera and the lenses 111, and the camera captured an image of the diffusion plate).

In this image, circular images show light that has passed through the lenses 111. An image partitioned by a circle of the single-dot chain line is included inside this circular image indicated by the double-dots chain line, and an image partitioned by a circle of the dotted line is included inside the circle of the single-dot chain line.

These circular lines show borderlines of ranges having difference levels in luminance. Therefore, the image of FIG. 19 includes multiple ranges according to luminance. Here, a region surrounded only by the dotted line is referred to as “ar1,” a region surrounded by the dotted line and the single-dot chain line is referred to as “ar2,” a region surrounded by the single-dot chain line and the double-dots chain line is referred to as “ar3,” and other region that is not surrounded by the dotted line, the single-dot chain line, and the double-dots chain line are referred to as “ar4.” When the luminance (cd/m2) of these regions ar1, ar2, ar3, and a4 are referred to as 1m1,1m2,1m3, and 1m4, the relationship among them satisfies 1m1>1m2>1m3>1m4.

Usually, in order to eliminate an unevenness in light amount in light from a backlight unit (backlight light), the smaller differences in luminance, the better. Thus, it can be said that it is desirable to make the region “ar1” having the highest luminance “1m1” in the image of FIG. 18 as narrow as possible within the region (ar1+ar2+ar3 representing the light that has passed through the lenses 111. (However, this is just one measure to suppress the unevenness in light amount, and there are also other measures, of course).

However, as it is clear from the image of FIG. 19, the ratio “ro” derived from arl divided by (ar1+ar2+ar3) is approximately 47%, which is not considered small. That is, even though the luminance in a front view improves in a backlight unit using light that passes through the hemispherical lenses 111, the unevenness in light amount cannot be prevented (that is to say, a light-emitting module “mj” including the hemispherical lens 111 emits light including the unevenness in light amount, and a backlight unit having the light-emitting modules “mj” also emits backlight light including the unevenness in light amount).

The present invention was devised in order to solve the above-mentioned problem. An object of the present invention is to provide a light-emitting module or the like that emits light in which an unevenness in light amount is suppressed.

### Means for Solving the Problems

A light-emitting module includes a light-emitting element and a lens that transmits light from the light element therethrough. In this light-emitting module, a depression is formed on an emission surface of the lens where it overlaps with the light-emitting element, and Formula (1) below is further satisfied:

8R≦13 Formula (1),

where “R” is the radius of curvature (unit: nm) of a curved surface extending from the depression to an outer edge of the emission surface.

With this structure, light from the light-emitting element is guided in radial directions by the depression in the center by the lens surface surrounding the depression. Particularly, because the curved surface of the lens surface surrounding this depression has a stronger curvature as compared to the curved surface of the lens surface having no depression, for example, light from the light-emitting element is diverged without being gathered in the vicinity of an area straightly above the depression. Therefore, this light-emitting module emits light having a uniform luminance as a whole without excessively increasing the luminance of the area straightly above the light-emitting element (that is, the light-emitting module emits light in which an unevenness in light amount is suppressed).

Moreover, if Formula (1) is satisfied, the curved surface of the lens surface surrounding this depression does not gather light of the light-emitting element to the vicinity of the area straightly above the depression, and diverges the light without making it travel excessively away from the depression. Therefore, the light-emitting module emits light having a uniform luminance as a whole with certainty.

Moreover, there is no special limitation for a material of the lens, but a material that satisfies Formula (2) below is preferable:

1.49≦nd≦1.50 Formula (2),

where “nd” is a refractive index of the material of the lens.

Further, it is preferable that the lens be a diffusion lens. This way, light transmitting through the diffusion lens is diffused, and therefore, light from the light-emitting module is not likely to include an unevenness in light amount.

Moreover, it is preferable that a back surface of the lens surface be a Lambertian-scattering surface. This way, light incident to the inside of the lens travels in various directions. Accordingly, light from the lens is not likely to include an unevenness in light amount.

Further, it is preferable that the Lambertian-scattering surface be a grained surface or a coated surface that is coated with scattering particles.

According to a lighting device including the above-mentioned light-emitting module, the light-emitting module emits light coming from the light-emitting element through the lens surface without causing light loss, and therefore, the illuminance of the entire range that is illuminated by the lighting-device (furthermore, the luminance of the entire illuminated range) is increased.

In such a lighting device, it is preferable that a second reflective sheet be interposed between respective lenses, and the reflectance of the second reflective sheet be 97% or more. This way, light from the light-emitting module is not likely to include a dark area corresponding to an area between the respective lenses, and therefore, light from the lighting device is not likely to include an unevenness in light amount.

Furthermore, a display device including the lighting device and a display panel (liquid crystal display panel, for example) that receives light from the lighting device provides a high quality image with no unevenness in light amount due to the increase in illuminance of the lighting device (an example of a device equipped with such a display device is a television-receiver device).

### Effects of the Invention

The light-emitting module of the present invention does not gather light to the vicinity of an area straightly above the light-emitting element and emits light having a uniform luminance as a whole. In other words, this light-emitting module emits light in which unevenness in light amount is suppressed.

### BRIEF DESCRIPTION OF THE DRAWINGS

FIG. 1 is an exploded perspective view of an LED module.

FIG. 2 is an exploded cross-sectional view of the LED module (here, the cross-sectional direction is along the line A1-A1′ viewed in the arrow direction in FIG. 1).

FIG. 3 is a schematic perspective view of a simulation device.

FIG. 4 is an image showing a luminance distribution of light emitted through two lenses.

FIG. 5 is a graph of the luminance distribution where the vertical axis shows the luminance (cd/m2), and the horizontal axis shows the position (position when the center of two adjacent lenses is “0”).

FIG. 6 is a graph of the luminance distribution where the vertical axis is a standardization luminance and the horizontal axis is position when the highest luminance shown in FIG. 5 is normalized to “1.0”.

FIG. 7A is a light path view showing light passing through lenses.

FIG. 7B is a light path view showing light passing through lenses.

FIG. 7C is a light path view showing light passing through lenses.

FIG. 8 is an image showing a luminance distribution of light emitted through two lenses (radius of curvature “R”=10 mm).

FIG. 9 is an image showing the luminance distribution of light emitted through two lenses (radius of curvature “R”=7.5 mm).

FIG. 10 is an exploded perspective view of an LED module.

FIG. 11 is an exploded cross-sectional view of the LED module (here, the cross-sectional direction is along the line A2-A2′ viewed in the arrow direction in FIG. 10).

FIG. 12 is a side view of LED modules.

FIG. 13 is a light path view showing a scattering at a back surface of the lens.

FIG. 14 is an explanatory view showing a comparison of the position and the luminance of the lenses.

FIG. 15 is an exploded perspective view of a liquid crystal display device.

FIG. 16 is an exploded perspective view of a liquid crystal television equipped with the liquid crystal display device.

FIG. 17 is a light path view of LED modules mounted in a conventional backlight unit.

FIG. 18 is a light path view of LEDs mounted in a conventional backlight unit.

FIG. 19 is an image showing a luminance distribution of light emitted through the two lenses of FIG. 17.

### DETAILED DESCRIPTION OF EMBODIMENTS

### Embodiment 1

One embodiment of the present invention will be described below based on the figures. Here, hatchings, member characters, and the like may be omitted for convenience, but in those cases, other figures should be referred to.

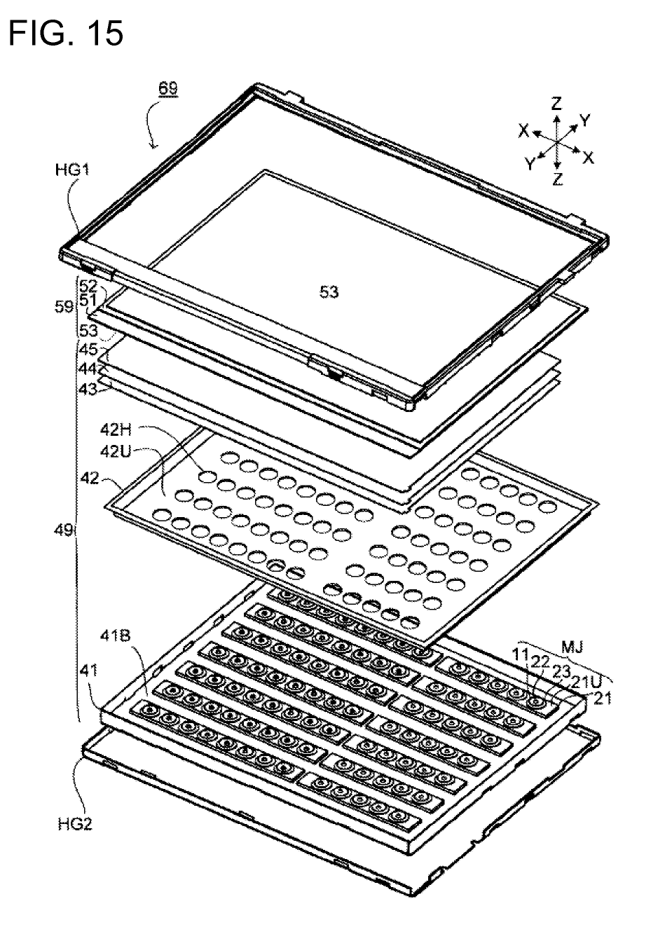

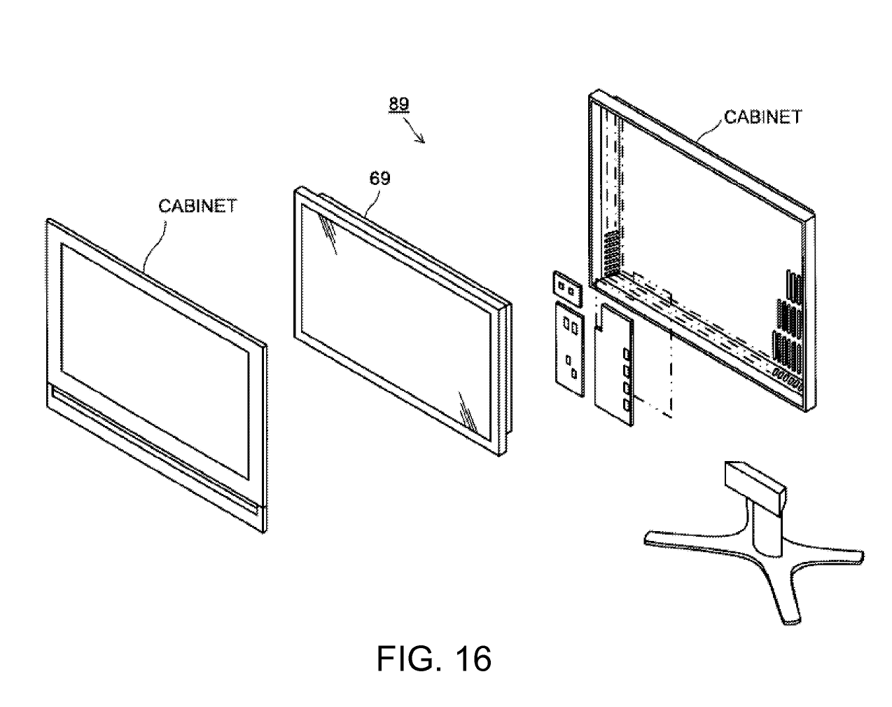

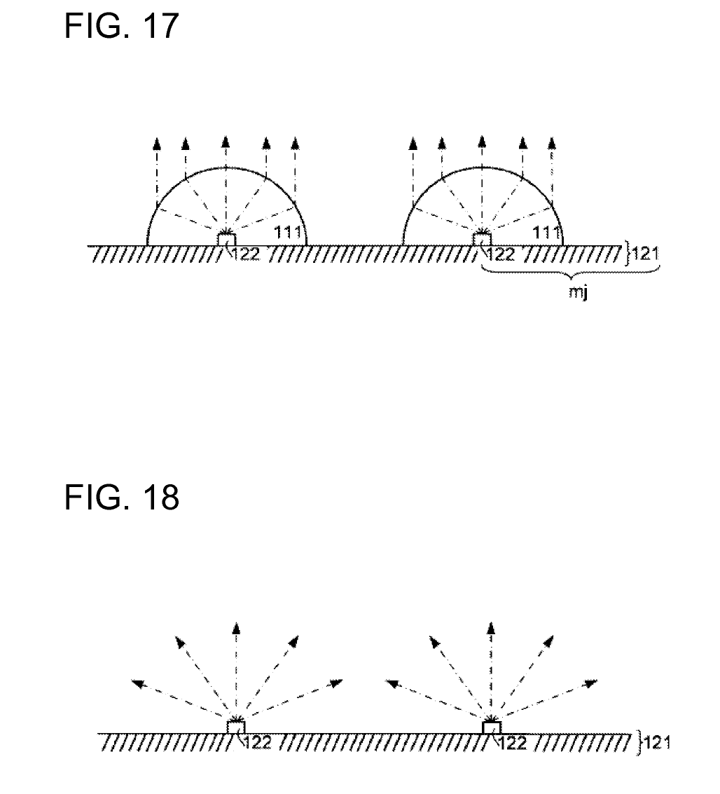

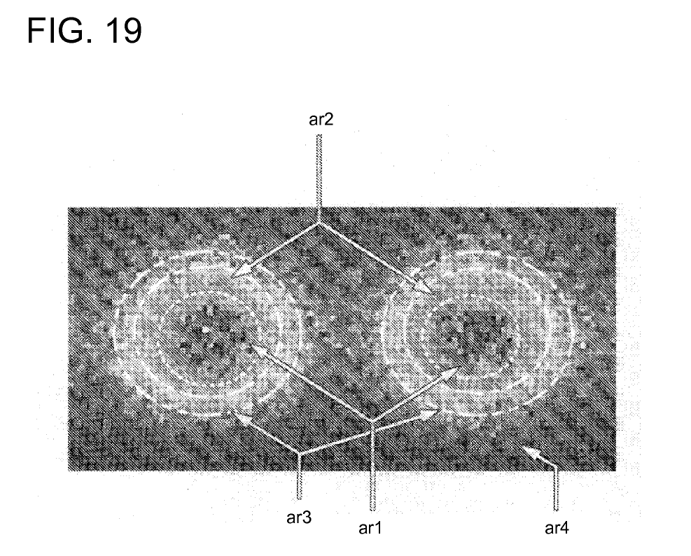

FIG. 16 is a liquid crystal television 89 equipped with a liquid crystal display device (display device) 69. Such a liquid crystal television 89 displays an image by receiving television broadcasting signals, and therefore, it can be called a television-receiver device. FIG. 15 is an exploded perspective view showing the liquid crystal display device. As shown in this figure, the liquid crystal display device 69 includes a liquid crystal display panel 59, a backlight unit (lighting device) 49 for supplying light to this liquid crystal display panel 59, and housings HG (front housing HG1, back housing HG2) sandwiching these.

In the liquid crystal display panel 59, an active matrix substrate 51 including switching elements such as TFTs (Thin Film Transistors) or the like, and an opposite substrate 52 facing this active matrix substrate 51 are bonded together by a sealing member (not shown in the figure). Then, liquid crystal (not shown in the figure) is injected into a gap between the two substrates 51 and 52.

On a light-receiving surface side of the active matrix substrate 51 and on an outgoing side of the opposite substrate 52, a polarizing film 53 is attached. The above-mentioned liquid crystal display panel 59 displays an image using the change in transmittance caused by an inclination of liquid crystal molecules.

Next, the backlight unit 49 positioned straightly below the liquid crystal display panel 59 is described. The backlight unit 49 includes LED modules (light-emitting modules) MJ, a backlight chassis 41, a large-sized reflective sheet 42, a diffusion plate 43, a prism sheet 44, and a micro lens sheet 45.

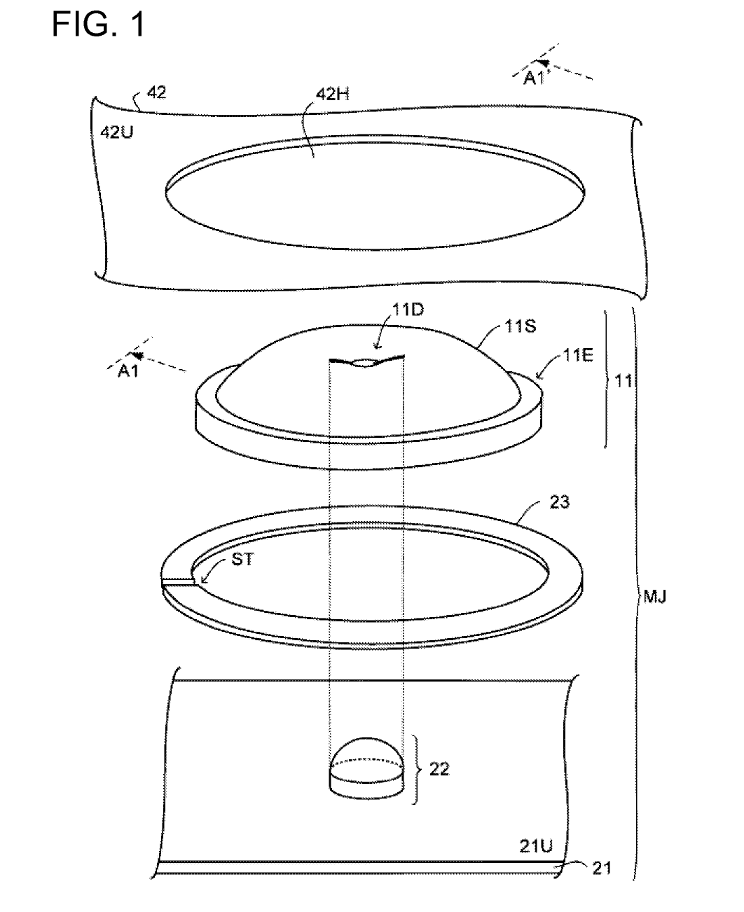

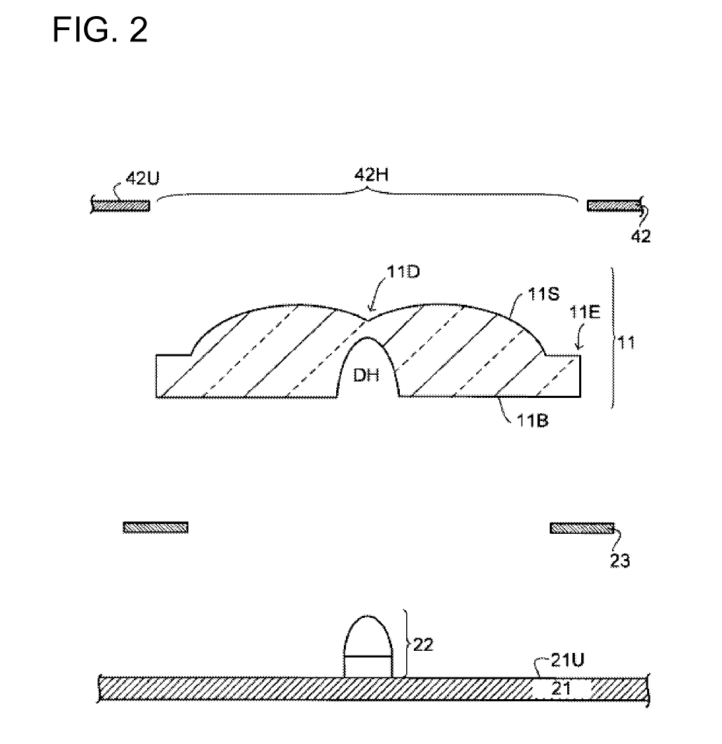

As shown in FIG. 1, which is a partial perspective view of FIG. 15, and in FIG. 2, which is a cross-sectional arrow view along the line A1-A1' of FIG. 1, an LED module MJ includes a mounting substrate 21, an LED (Light Emitting Diode) 22, a lens 11, and a built-in reflective sheet 23.

The mounting substrate 21 is a plate-like rectangular substrate, and on its mounting surface 21U, a plurality of electrodes (not shown in the figure) are disposed. Then, on these electrodes, LED 22, which is a light-emitting element, is attached. Further, on the mounting surface 21U of the mounting substrate 21, a resist film (not shown in the figure), which is to be a protective film, is formed. There is no special limitation for this resist film, but it is preferable that the color be white having reflectivity. This is because even if light enters the resist film, the light is reflected by the resist film and travels toward the outside, thereby eliminating a cause of an unevenness in light amount, which is light absorption by the mounting substrate 21.

The LED 22 is a light source, and emits light by a current through the electrodes on the mounting substrate 21. There are many different kinds for the LED 22, and LEDs 22 such as below are some examples. One example is an LED 22 including a blue-light emitting LED chip (light-emitting chip) and a fluorescent member that emits yellow fluorescent light by receiving light from the LED chip (here, there is no special limitation for the number of the LED chips). Such an LED 22 generates white light by light from the blue-light emitting LED chip and the fluorescent light.

However, a fluorescent member built in an LED 22 is not limited to a fluorescent member that emits yellow fluorescent light. For example, an LED 22 may include a blue-light emitting LED chip and a fluorescent member that emits green and red fluorescent light by receiving light from the LED chip, to generate white light by the blue light from the LED chip and the fluorescent light (green light and red light).

Moreover, an LED chip built in an LED 22 is not limited to an LED chip that emits blue light. For example, an LED 22 may include a red LED chip that emits red light, a blue LED chip that emits blue light, and a fluorescent member that emits green fluorescent light by receiving light from the blue LED chip. Such an LED 22 can generate white light by red light from the red LED chip, blue light from the blue LED chip, and the green fluorescent light.

Further, an LED 22 including no fluorescent member may be used as well. For example, an LED 22 may include a red LED chip that emits red light, a green LED chip that emits green light, and a blue LED chip that emits blue light, to generate white light by light from all of the LED chips.

Moreover, mounted in the backlight unit 49 shown in FIG. 15 are a relatively short mounting substrate 21 where five LEDs 22 are aligned in a line on one mounting substrate 21, and a relatively long mounting substrate 21 where eight LEDs 22 are aligned in a line on one mounting substrate 21.

Specifically, the two kinds of mounting substrates 21 are aligned such that a line of five LEDs 22 and a line of eight LEDs 22 are aligned so as to become a line of thirteen LEDs 22, and further, the two kinds of mounting substrates 21 are also arranged in a direction crossing (such as perpendicular to) the direction in which the thirteen LEDs 22 are aligned. This way, the LEDs 22 are arranged in a matrix, and emit planar light (for convenience, the direction in which different kinds of mounting substrates 21 are aligned is called an X direction, the direction in which the same kind of mounting substrates 21 are aligned is called a Y direction, and a direction crossing these X direction and Y direction is called a Z direction).

Moreover, the thirteen LEDs 22 aligned in the X direction are electrically connected in series, and these thirteen LEDs 22 connected in series are further electrically connected in parallel to another thirteen LEDs 22, which are adjacent along the Y direction and are connected in series. These LEDs 22 arranged in a matrix are driven parallelly.

The lens 11 receives light from an LED 22, and transmits (emits) the light. To describe the detail, the lens 11 has a housing recess DH that can house the LED 22 on a back surface (light-receiving surface) side of a lens surface 11S, and covers over the LED 22 such that the position of the containing recess DH and the LED 22 match each other. Then, the LED 22 is embedded inside the lens 11, and light from the LED 22 is supplied to the inside of the lens 11 with certainty. A large part of the supplied light is emitted to outside through the lens surface 11S (further details of the lens surface (emission surface) 11S will be described later).

There is no special limitation for the material of the lens 11, but an acrylic resin may be used, for example (one example is an acrylic resin having the refractive index “nd” of 1.49 or more and 1.50 or less).

The built-in reflective sheet 23 is interposed between the lens 11 and the mounting substrate 21. This built-in reflective sheet 23 prevents the mounting surface 21U of the mounting substrate 21 from being exposed through a passage hole 42H, which is formed in the large-sized reflective sheet 42 as a passage for the lens 11.

To explain in detail, the large-sized reflective sheet 42 has the passage hole 42H, which is larger than the outside diameter of the lens 11, in order to expose the lens 11 from its reflective surface 42U. Therefore, when the lens 11 is exposed from the reflective surface 42U of the large-sized reflective sheet 42, there is a concern that a gap may be created between an outer edge 11E of the lens 11 and an inner edge of the passage hole 42H, and the mounting surface 21U of the mounting substrate 21 may be exposed from the gap. Therefore, the built-in reflective sheet 23 has a shape that rims the outer edge 11E of the lens 11, that is, a ring-like shape shown in FIG. 1, for example.

Further, this built-in reflective sheet 23 shown in FIG. 1 is not a continuously connected ring, but it has a slit ST. This slit ST is for attaching the built-in reflective sheet 23 near the outer edge 11E of the lens 11 even after the mounting substrate 21 and the lens 11 are attached. However, the slit ST is not mandatory.

For example, even though the built-in reflective sheet 23 has a continuous ring shape, the built-in reflective sheet 23 only needs to be interposed between the lens 11 and the mounting substrate 21 before the lens 11 is attached to the mounting substrate 21 (here, a reflective surface of the built-in reflective sheet 23 is called a built-in reflective surface 23U).

The backlight chassis 41 is a box-shaped member as shown in FIG. 15, for example, and contains a plurality of LED modules MJ by arranging the LED modules MJ on a bottom surface 41B. Here, the bottom surface 41B of the backlight chassis 41 and the mounting substrates 21 of the LED modules MJ are connected to each other by rivets, which are not shown in the figure.

Moreover, support pins for supporting the diffusion plate 43, the prism sheet 44, and the micro lens sheet 45, which will be described later, may be attached to the bottom surface 41B of the backlight chassis 41 (further, the backlight chassis 41 may laminate the diffusion plate 43, the prism sheet 44, and the micro lens sheet 45 in this order, and support them by the top of the side walls along with the support pin).

The large-sized reflective sheet 42 is an optical sheet having the reflective surface 42U, and covers over the plurality of LED modules MJ arranged in a matrix such that a back surface of the reflective surface 42U faces the LED modules MJ. Here, the large-sized reflective sheet 42 has the passage holes 42H, which correspond to the position of the lenses 11 of the LED modules MJ, and expose the lenses 11 on the reflective surface 42U (further, holes for exposing the above-mentioned rivets and support pins may preferably be formed).

This way, even though a part of light emitted from the lenses 11 travels toward the side of the bottom surface 41B of the backlight chassis 41, the light is reflected by the reflective surface 42U of the large-sized reflective sheet 42 and travels away from the bottom surface 41B. Accordingly, due to the large-sized reflective sheet 42, light from the LEDs 22 travels toward the diffusion plate 43, which faces the reflective surface 42U, without causing light loss.

The diffusion plate 43 is an optical sheet that overlaps with the large-sized reflective sheet 42, and diffuses light emitted from the LED modules MJ and reflected light coming from the large-sized reflective sheet 42U. In other words, the diffusion plate 43 diffuses planar light formed by the plurality of LED modules MJ, and spreads the light to the entire region of the liquid crystal display panel 59. Moreover, it is preferable that the diffusion plate 43 have transmittance of 52% or more and 60% or less. This is because such a diffusion plate 43 can diffuse light while moderately transmitting it so as to suppress the unevenness in light amount.

The prism sheet 44 is an optical sheet overlapping the diffusion plate 43. In this prism sheet 44, triangle prisms extending in one direction (in linear shape), for example, are aligned in a direction perpendicular to the one direction on the sheet surface. This way, the prism sheet 44 changes directional properties in the radiation characteristics of light from the diffusion plate 43. Here, it is preferable that the prisms extend along the Y direction in which less LEDs 22 are aligned, and be aligned along the X direction in which more LEDs 22 are aligned.

The micro lens sheet 45 is an optical sheet overlapping the prism sheet 44. This micro lens sheet 45 has particles dispersed inside thereof for light refraction and scattering. Accordingly, the micro lens sheet 45 suppresses the difference in luminance (unevenness in light amount) without locally concentrating light from the prism sheet 44.

The above-mentioned backlight unit 49 transmits planar light formed by the plurality of LED modules MJ through the plurality of optical sheets 43 to 45, and supplies the light to the liquid crystal display panel 59. Accordingly, the non-light-emitting type liquid crystal display panel 59 receives light (backlight light) from the backlight unit 49 to improve the display function.

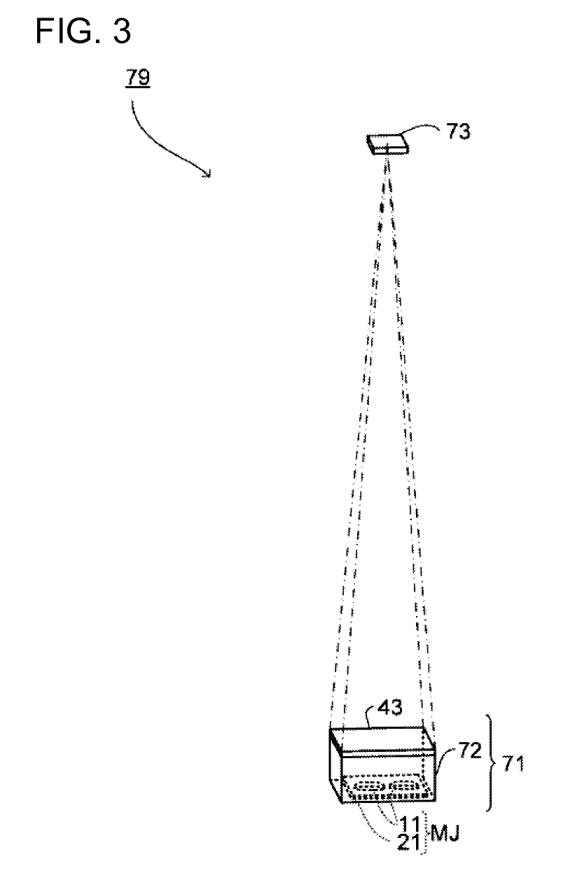

Here, the luminance of light emitted from the lens 11 of an LED module MJ is described. FIG. 3 is a schematic view of a simulation device 79. This simulation device 79 includes a test unit 71 and a camera 73.

In the test unit 71, the bottom surface is a reflective surface having a reflectance of approximately 97%, and the inner walls are reflective surfaces having a reflectance of approximately 100%. Further, an LED module MJ including two lenses 11 is mounted in a box 72 having an opening. Further, the test unit 71 has a diffusion plate 43 disposed in the opening of the box 72 so that the light from the LED module MJ transmits through the diffusion plate 43.

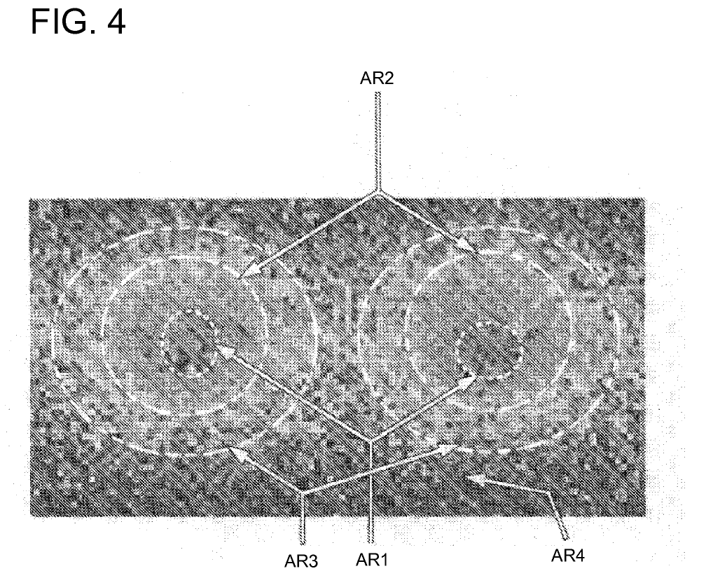

The camera 73 takes a picture of the diffusion plate 43 to measure the luminance of a surface of the diffusion plate 43. Specifically, as shown in FIG. 4, the camera 73 takes an image in which the difference in luminance of each area is recognizable two dimensionally.

As shown in this FIG. 4, an image showing two circles (circles of a double-dots chain line) is obtained by the camera 73. This image of circles shows light that has passed through the lenses 11. Moreover, an image partitioned by a circle of a single-dot chain line is included inside this circular image of the double-dots chain line, and an image partitioned by a circle of a dotted line is further included inside the circle of the single-dot chain line.

These circular lines show borderlines of ranges having difference levels in luminance. Thus, the image of FIG. 4 includes multiple ranges according to the luminance. Here, a region surrounded only by the dotted line is referred to as “AR1”, a region surrounded by the dotted line and the single-dot chain line is referred to as “AR2”, a region surrounded by the single-dot chain line and the double-dots chain line is referred to as “AR3”, and other region that is not surrounded by the dotted line, the single-dot chain line, and the double-dots chain line is referred to as “AR4”. When the luminance (cd/m2) of these regions AR1, AR2, AR3, and AR4 are referred to as LM1, LM2, LM3, and LM4, the relationship among them satisfies LM1>LM2>LM3>LM4 (when LM1, LM2, LM3, and LM4 are normalized to the highest value of the luminance, LM1>66%, 50%<LM2 6%, 30%<LM350%, and LM4 30% are satisfied).

Usually, in order to eliminate the unevenness in light amount in light from the backlight unit 49 (backlight light), the smaller the difference in luminance, the better. Thus, it can be said that it is desirable to make the region “AR1,” which has the highest luminance “LM1” in the simulation result shown in FIG. 4, as narrow as possible within the region (AR1+AR2+AR3) representing light that has passed through the lenses 11 (however, this is just one measure to suppress the unevenness in light amount, and there are also other measures, of course).

Here, in order to minimize a ratio “RO” derived from AR1 divided by (AR1+AR2+AR3) as much as possible, the lens 11 has a depression 11D where a part of the lens surface 11S overlapping with the housing recess DH (that is, the LED 22) is depressed, as shown in FIGS. 1 and 2.

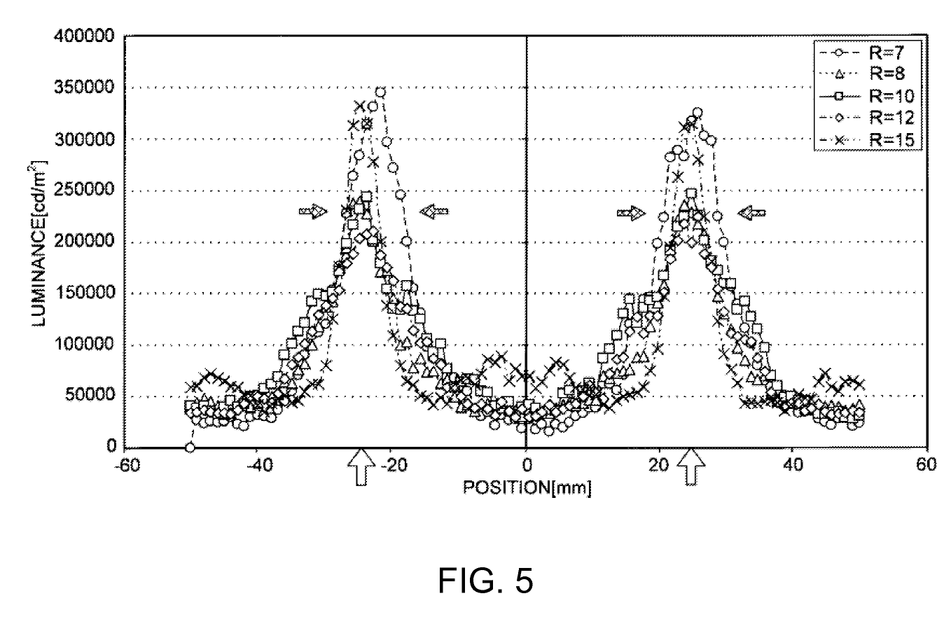

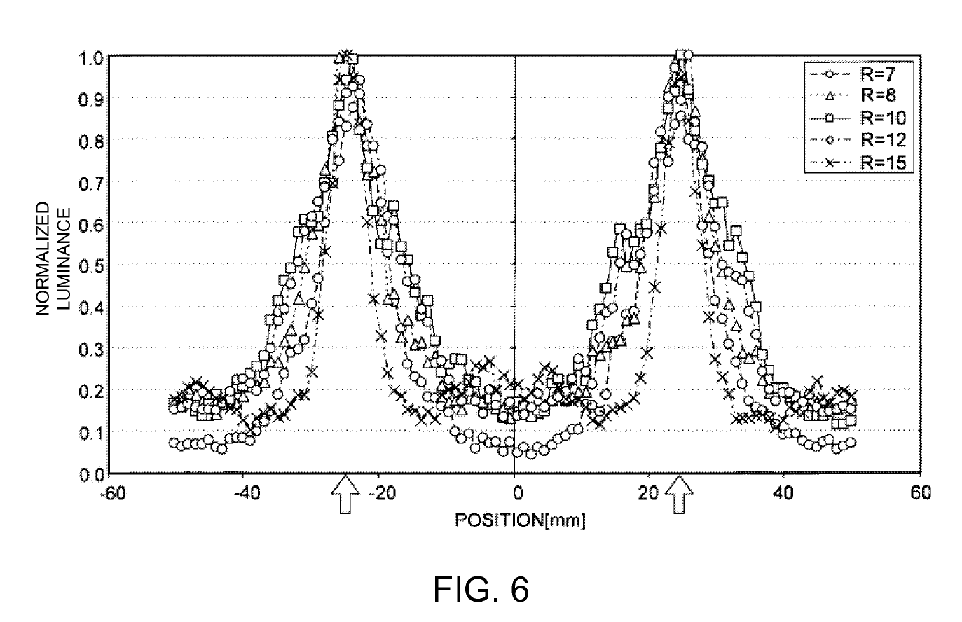

FIG. 5 represents the image of the luminance distribution (see FIG. 4) of the light transmitting through such a lens surface 11S as a graph in which the vertical axis is the luminance (cd/m2), and the horizontal axis is the position (position with the center of the two adjacent lenses being “0”). FIG. 6 is a graph showing normalized luminance in the vertical axis and the position in the horizontal axis by normalizing the highest luminance shown in FIG. 5 as “1.0”. Here, the positions of white arrows in FIGS. 5 and 6 are the positions of the LEDs 22. Based on FIGS. 4 to 6, Formula (P1) below is derived.

8≦R≦13 Formula (P1),

where “R” is the radius of curvature (unit: mm) of the curved surface from the depression 11D to the outer edge 11E of the lens surface 11S.

R(mm)=8, 10, and 12 in FIGS. 5 and 6 satisfy Formula (P1) for the radius of curvature. As shown in FIG. 5, when the radius of curvature R is within Formula (P1), their highest luminance is lower than the highest luminance in the cases of other radius of curvature (R=7, 15).

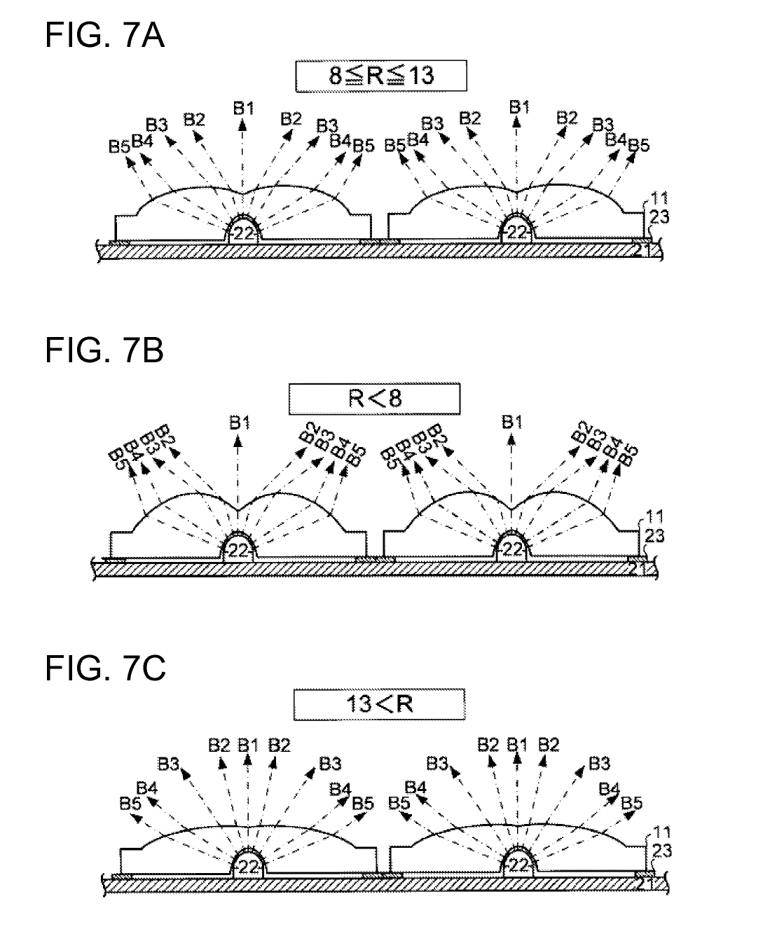

This is because, as shown in the schematic light path view of FIG. 7A, light (B1 to B5) traveling from the center of the lens surface 11S to the outer edge 11E is emitted in a radial fashion without unevenly spreading (here, light B1 is a light passing in the vicinity of the depression 11D of the lens surface 11S, and as a number assigned to light B becomes larger, light passes through a position that is further away from the depression 11D and closer to the outer edge 11E of the lens surface 11S).

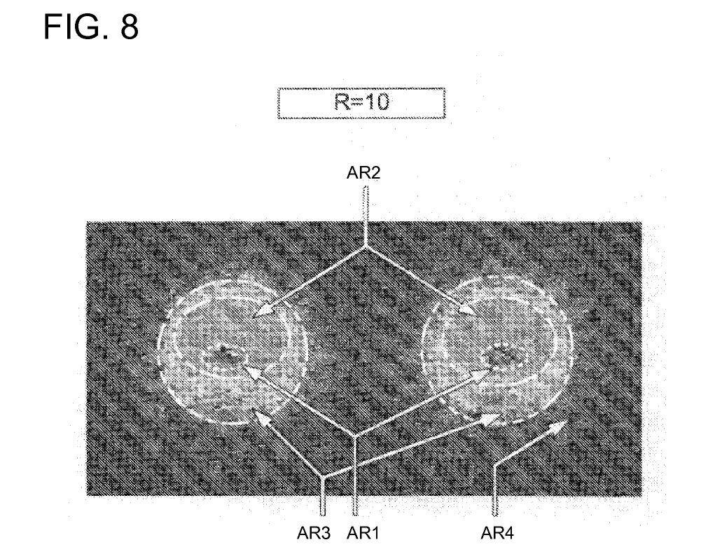

The lens surface 11S especially makes light B2, which is a light with the relatively strong light intensity, travel away from the light B1, which has the strongest light intensity. Accordingly, the size of the region “AR1” showing the highest luminance “LM1” is likely to become small (ratio “RO”≈41%). This is apparent from FIG. 8 showing an image of light that has passed through the lens surface 11S having the radius of curvature R of 10 (mm).

Meanwhile, when the radius of curvature R is outside the range of Formula (P1), that is, when the radius of curvature R is less than 8(mm) (R<8), for example, as shown in

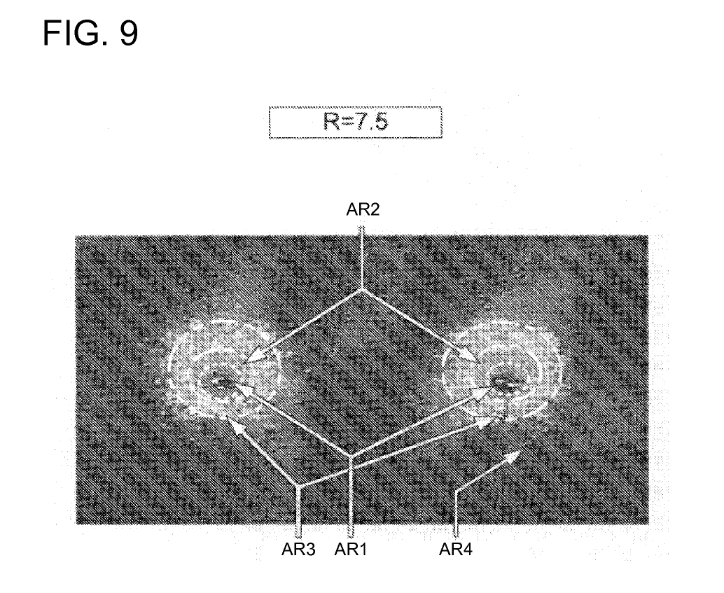

FIG. 7B, light convergence by the curved surface becomes excessively increased. Thus, light (light B2 to light B5) other than the light passing through the depression 11D is converged (see the checkered arrows in FIG. 5). Accordingly, as shown in the image (R=7.5) of FIG. 9, a region (AR1+AR2+AR3) showing light that has passed through the lenses 11 becomes relatively small.

When light is excessively converged, and a region showing light that has passed through the lenses 11 is small as just described, even though the light passes through the diffusion plate 43, the light is not likely to be diffused sufficiently (in other words, the denominator of the ratio RO is likely to become small, and the ratio RO does not decrease). Therefore, the unevenness in light amount is not resolved in the lens 11 having the curvature R below the lower limit of Formula (P1).

Moreover, it is possible that the converged light (light B2 to B5) other than the light passing through the depression 11D has a higher luminance than the light B1 passing through the depression 11D. In this case, light emitted from the lens 11 forms a ring shape, and the difference in luminance is caused between the center of the ring and the ring itself, and therefore, this difference in luminance can possibly become a cause for the unevenness in light amount.

Next, when the radius of curvature R is larger than 13(mm) (13<R), for example, as shown in FIG. 7C, light convergence that is caused by the curved surface is excessively decreased. As a result, among light other than the light passing through the depression 11D, the light B2 near the light B1 cannot be refracted and travel away from the light B1.

Therefore, as shown in FIGS. 5 and 6, the difference in luminance between an area near the LED 22 and an area away from the LED 22 becomes larger than the case of other radius of curvature R, thereby causing an unevenness in light amount. Accordingly, the unevenness in light amount is not resolved in the lens 11 having the curvature R above the upper limit of Formula (P1).

In the view of the foregoing, when the depression 11D is formed on the lens surface 11S of the lens 11, curved surfaces separated by the depression 11D are formed on the lens surface 11S, and light passing through the lens surface 11S does not concentrate light having the relatively strong light intensity to one place as compared to light passing through a lens surface without any depression (see the light B1 and B2 shown in FIG. 7A).

This is because the curved surface of the lens surface 11S surrounding this depression 11D has a stronger curvature compared to the curved surface of a lens surface having no depression, and therefore, light from the LEDs 22 is diffused without being concentrated in the vicinity of an area straightly above the depression 11D (thus, the lens 11 can be functioned as a diffusion lens). In other words, light from the LED 22, which is covered by the depression 11D, is guided in radial directions with the depression 11D as the center by the lens surface 11S surrounding the depression 11D.

Particularly, when a lens surface 11S satisfying Formula (P1) is used, the curved surface of the lens surface 11S surrounding this depression 11D does not concentrate light of LEDs 22 in the vicinity of the area straightly above the depression 11D, and diverges the light without making it travel excessively away from the depression 11D (see FIG. 7A). Therefore, the LED module MJ emits light having a uniform luminance as a whole without excessively increasing the luminance of the area straightly above the LED 22 (that is to say, the LED module MJ emits light in which the unevenness in light amount is suppressed).

Accordingly, an LED module MJ including such a lens 11 emits light in which the unevenness in light amount is suppressed, and due to this, backlight light from the backlight unit 49 includes no unevenness in light amount. Further, the unevenness in light amount is suppressed in the light itself emitted from the LED modules MJ, and therefore, the number of optical sheets included in the backlight unit 49 for preventing the unevenness in light amount may be reduced (that is to say, a cost of the backlight unit 49 is reduced, and the backlight unit 49 also becomes thin).

### Other Embodiments

The present invention is not limited to the above-mentioned embodiment, and various modifications are possible within the spirit of the present invention.

For example, in a direct-type backlight unit, a light guide panel is usually omitted, and LEDs emit light directly onto an optical sheet (diffusion plate or the like). However, if the light is not diverged to a certain degree before reaching the optical sheet, the light may include the unevenness in light amount when going through the optical sheet. Therefore, it is preferable that the distance between the LEDs and the diffusion plate be large.

However, when the lens 11 that includes the lens surface 11S having the depression 11D covers each LED 22, light from the LEDs 22 is sufficiently diffused before reaching the diffusion plate 43, and therefore, backlight light from the backlight unit 49 includes no unevenness in light amount. Moreover, the distance between the LEDs 22 and the diffusion plate 43 can be made relatively small as well (that is to say, a relatively thin backlight unit 49 is achieved, and therefore, the liquid crystal display device 69 equipped with the same is likely to become thin as well).

However, in the backlight unit 49 equipped with the LED modules MJ shown in FIG. 15, many LEDs 22 are mounted, and each of the LEDs 22 is further covered by a lens 11. Accordingly, heat caused by driving the LEDs 22 is likely to stay in the narrow space of the housing recess DH of the lens 11 (moreover, the LEDs 22 cannot maintain the relatively high light intensity due to the driving heat of themselves).

Therefore, it is preferable that the LED modules MJ be attached to the backlight chassis 41 formed of a material having good heat dissipation capability, that is, a metal, for example. This way, a separate heat dissipation member that would otherwise be placed between the mounting substrate 21 and the bottom surface 41B of the backlight chassis 41, for example, becomes unnecessary, thereby achieving the backlight unit 49 that is capable of maintaining light intensity over a long time while keeping the cost low.

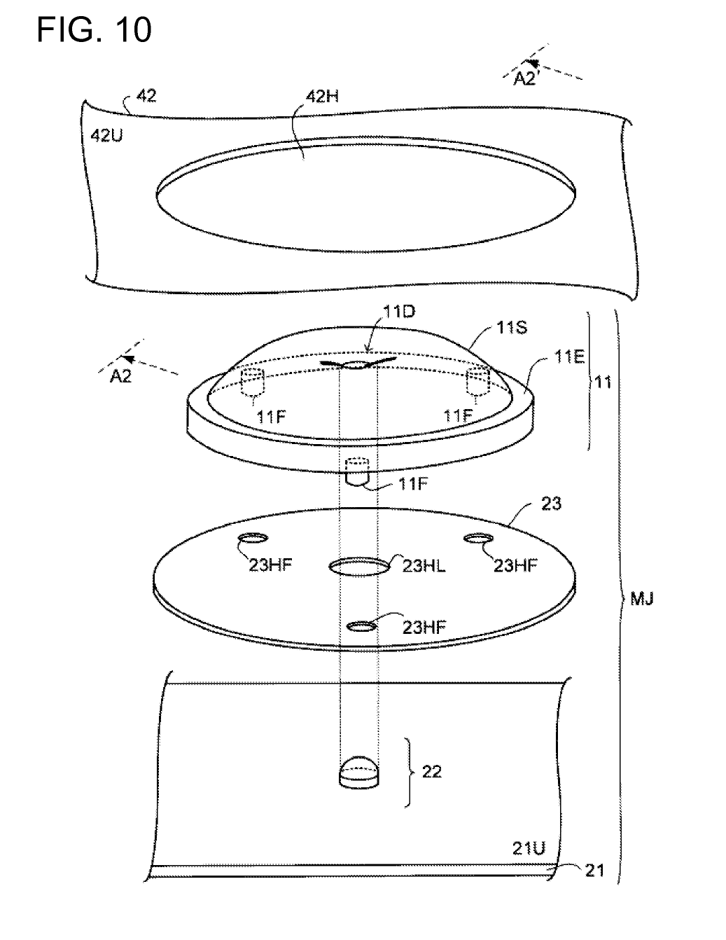

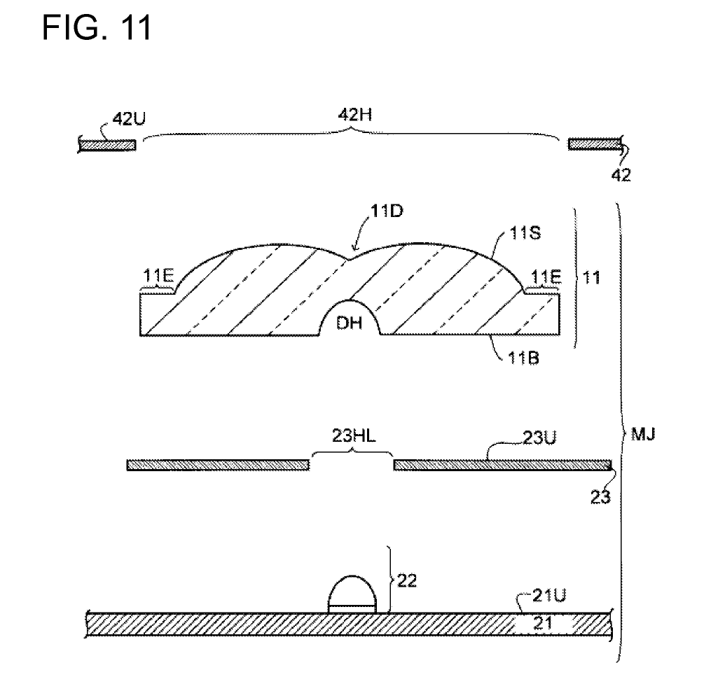

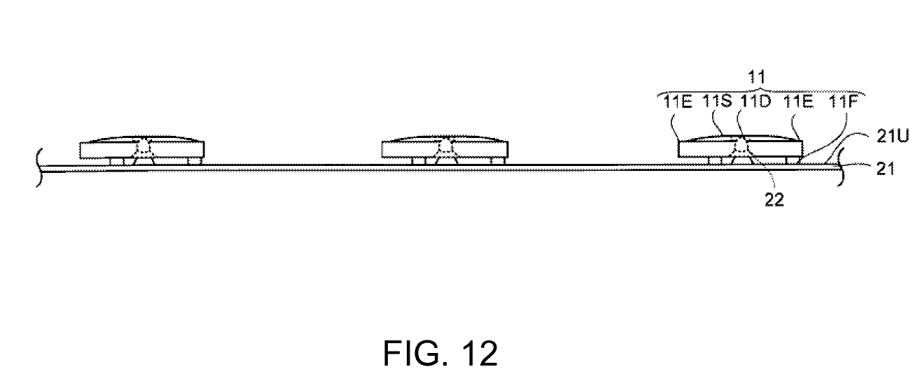

Further, from the standpoint of dissipating driving heat of the LEDs 22, as shown in FIGS. 10 to 12, it is preferable that leg parts 11F be formed in a lens 11. FIG. 10 is a partial perspective view of an LED module MJ, and FIG. 11 is a cross-sectional view along the arrow line A2-A2′ of FIG. 10. FIG. 12 is a partial side view of the LED module MJ (in FIG. 12, the built-in reflective sheet 23 and the large-sized reflective sheet 42 are omitted for convenience).

As shown in these figures, the leg parts 11F of the lens 11 are formed so as to protrude from the back surface 11B of the lens surface 115. Further, the built-in reflective sheet 23 has leg-passage holes 23HF for having the leg parts 11F of the lens 11 pass therethrough so that the built-in reflective sheet 23 does not block the connection between the lens 11, which covers the built-in reflective sheet 23, and the mounting substrate 21. That is, this built-in reflective sheet 23 is interposed between the lens 11 and the mounting substrate 21 by being covered by the lens 11 (of course, the built-in reflective sheet 23 has an LED-passage hole 23HL for exposing the LED 22 from the built-in reflective surface 23U, and therefore, it does not block light from the LED 22).

The tips of these leg parts 11F are attached to the mounting surface 21U of the mounting substrate 21 so that the lens 11 is attached to the mounting substrate 21.

This way, a gap is created between the mounting surface 21U and the lens 11 (specifically, a gap is created between the back surface 11B of the lens 11 and the mounting surface 21U of the mounting substrate 21). Thus, even when the LED 22 becomes hot due to light emission, the heat is cooled down through the gap.

To explain in more detail, through the gap, external air enters the housing recess DH that houses the LED 22, and the heat in the LED 22 easily escapes (that is, because a gap is created between the back surface 11B of the lens 11 and the mounting surface 21U due to the leg parts 11F of the lens 11, driving heat of the LED 22 does not stay in the narrow space between the housing recess DH of the lens 11, and easily escapes to outside). As a result, the junction temperature of the LED 22 does not become high, and the LED 22 can emit light without decreasing the luminance.

Moreover, as shown in FIGS. 10 and 11, the built-in reflective sheet 23 is circular, and the built-in reflective surface 23U is covered by the back surface 11B of the lens 11. Therefore, in this LED module MJ, it is not the case that the light reflected by the back surface 11B of the lens 11 is absorbed by the mounting surface 21U, or does not enter the back surface 11B of the lens 11 because it is reflected by the mounting surface 21U, for example. That is, light from the LED 22 is emitted through the lens 11 without being lost.

As a result, light emitted from the LED module MJ is not likely to include an unevenness in light amount.

Further, this built-in reflective surface 23U may be a minor surface (a Gaussian-scattering surface, for example) or a rough surface formed into a grained surface or the like (a Lambertian-scattering surface, for example).

The built-in reflective surface 23U for Lambertian-scattering includes a grain pattern. But there is no special limitation for the method of forming the grain pattern (grain treatment). For example, the grain pattern may be formed by various methods, such as masking, roll transfer, extrusion treatment, or the like.

Other than the grain treatment, beads for scattering light (scattering particles) may be coated on the built-in reflective surface 23U. That is, the built-in reflective surface 23U may be a coated surface coated with beads as long as it causes Lambertian-scattering. Further, the surface roughness [Ra] of the built-in reflective surface 23U having such a rough surface is 400 nm or more.

Moreover, a rough surface (Lambertian-scattering surface) formed by the grain treatment or the like may be formed on the back surface 11B of the lens 11. This way, light that directly entered the back surface 11B of the lens 11 from the LED 22 is scattered.

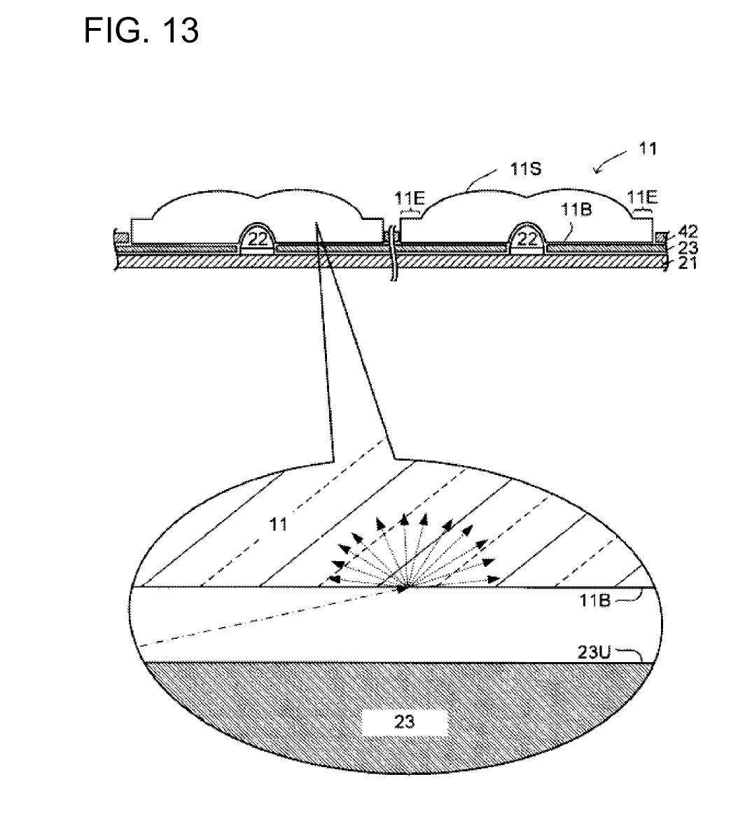

With this configuration, even if a part of light scattered in various directions enters the built-in reflective surface 23U of the built-in reflective sheet 23, most of the light returns to the back surface 11B of the lens 11, and enters the inside of the lens 11. Moreover, other part of the light diffused in various directions also travels as shown in the light path view of FIG. 13. In other words, a part of light (single-dot chain arrow line) that reached the back surface 11B of the lens 11 continues to enter the inside of the lens 11 while being scattered.

As a result, light of the LED 22 is emitted through the lens 11 without loss with certainty, and the illuminance is further increased in the entire range that is illuminated by the LED modules MJ. Further, such a scattered condition has been recognized as a relatively good result by a test using an optical analysis software SPEOS manufactured by OPTIS Asia & Pacific K.K, for example.

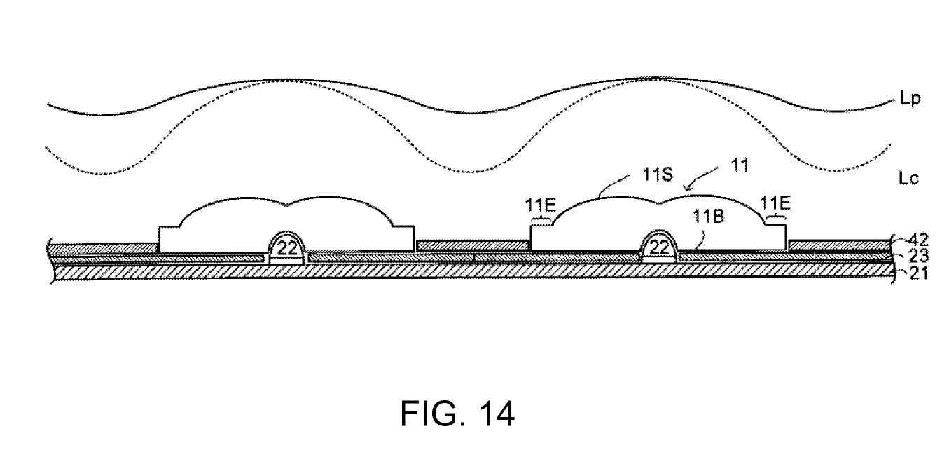

Moreover, it is preferable that the large-sized reflective sheet 42 have the reflectance of 97% or more. This way, as shown in FIG. 14, which illustrates the positions of the lenses 11 and luminance curves Lp and Lc, the luminance in the vicinity of an area straightly above between the lenses 11 does not become excessively low compared to the luminance in the vicinity of the area straightly above the lenses 11.

To explain in more detail, the luminance curve Lp shows the luminance of light coming from an LED module MJ covered by the large-sized reflective sheet 42 having the reflectance of 97%. The luminance curve Lc shows the luminance of light coming from an LED module MJ that is not covered by the large-sized reflective sheet 42 (here, the highest luminance is approximately same for the luminance curves Lp and Lc). As shown in the luminance curve Lc and the luminance curve Lp of FIG. 14, a difference between the luminance in the vicinity of the area straightly above the lenses 11 and the luminance in the vicinity of an area straightly above between the lenses 11 is smaller in the luminance curve Lp than the corresponding difference in the luminance curve Lc.

The size of this difference in luminance indicates whether or not light from the backlight unit 49 contains an unevenness in light amount (that is, an unevenness in light amount is considered to occur if the difference in luminance is large). The above results indicate that an unevenness in light amount occurs in light coming from the backlight unit 49 equipped with LED modules MJ not covered by the large-sized reflective sheet 42, while an unevenness in light amount does not occur in light coming from the backlight unit 49 equipped with LED modules MJ covered by the large-sized reflective sheet 42 having the reflectance of 97%. In other words, it is preferable that the large-sized reflective sheet 42 having the reflectance of 97% be mounted in the backlight unit 49.

Further, an LED 22, that is, a light-emitting element, was described above as a light source, but there is no limitation to this. For example, a light-emitting element formed by a self-luminous material such as an organic EL (Electro-Luminescence) or an inorganic EL may also be used.

Moreover, an acrylic resin was described above as one example of a material for the lens 11, but there is no limitation to this, and other transparent resin or the like may also be used. Furthermore, the lens 11 having a curved surface that satisfies Formula (P1) is designed based on a material having the refractive index “nd” of approximately 1.49 or more and 1.50 or less, and therefore, it can be said that an acrylic resin is preferable. However, other refractive index “nd” may satisfy Formula (P1), and therefore, other transparent resin, glass, or the like may, of course, be used as well.

### DESCRIPTION OF REFERENCE CHARACTERS

11 Lens

11E Outer edge of lens

11S Lens surface

11D Depression

11F Leg part

11HL LED-passage hole

11HF Leg-passage hole

21 Mounting substrate

21U Mounting surface

22 LED (light-emitting element, light source)

23 Built-in reflective sheet

MJ LED module (light-emitting module)

41 Backlight chassis

43 Diffusion plate

44 Prism sheet

45 Micro lens sheet

49 Backlight unit (lighting device)

59 Liquid crystal display panel (display panel)

69 Liquid crystal display device (display device)

71 Test unit

73 Camera

79 Simulation device

89 Liquid crystal television (television-receiver device)

1. A light-emitting module, comprising:
a light-emitting element;
a lens that transmits light from said light-emitting element therethrough; and
a mounting substrate having said light-emitting element and said lens mounted thereon,
wherein a depression is formed on an emission surface of said lens at a position corresponding to said light-emitting element, and
wherein Formula (1) below is satisfied:
8≦R≦13 Formula (1),
where “R” is the radius of curvature (unit: mm) of a curved surface from said depression to an outer edge of said emission surface.

2. The light-emitting module according to claim 1, wherein a material of said lens satisfies Formula (2) below:
1.49≦nd≦1.50 Formula (2),
where “nd” is a refractive index of the material of said lens.

3. The light-emitting module according to claim 1, wherein said lens is a diffusion lens.

4. The light-emitting module according to claim 1, wherein a back surface of said lens is a Lambertian-scattering surface.

5. The light-emitting module according to claim 4, wherein said Lambertian-scattering surface is a grained surface or a coated surface that is coated with scattering particles.

6. A lighting device comprising a plurality of the light-emitting modules according to claim 1.

7. The lighting device according to claim 6,
wherein a reflective sheet is interposed between the respective lenses, and
wherein a reflectance of said reflective sheet is 97% or more.

8. A display device, comprising:
the lighting device according to claim 6, and
a display panel that receives light from said lighting device.

9. The display device according to claim 8, wherein said display panel is a liquid crystal display panel.

10. A television-receiver device comprising the display device according to claim 8.
